(19) United States
(12) Patent Application Publication
(10) Pub. No.: US 2025/0342191 A1
(43) Pub. Date: Nov. 6, 2025

(54) SYSTEMS AND METHODS FOR QUERYING GRAPH DATABASES USING NATURAL LANGUAGE QUERIES

(71) Applicant: The MITRE Corporation, McLean, VA (US)

(72) Inventors: Steven Earl NOEL, Woodbridge, VA (US); Vipin Swarup, McLean, VA (US); Eric James Wolos, San Diego, CA (US)

(73) Assignee: The MITRE Corporation, McLean, VA (US)

(21) Appl. No.: 18/653,080

(22) Filed: May 2, 2024

(51) Int. Cl. G06F 16/33; G06F 16/35; G06F 16/901; G06N 3/0895

(52) U.S. Cl. CPC G06F 16/3344; G06F 16/3347; G06F 16/353; G06F 16/9024; G06N 3/0895

(57) ABSTRACT

A method for querying a graph database using natural language queries comprises: receiving a natural language user query; identifying one or more node types from a type graph in the natural language user query, wherein the one or more node types correspond to one or more words or phrases in the natural language user query; generating, using a large language model, a graph database query based on the one or more node types identified in the natural language user query; querying a graph database using the graph database query generated by the large language model; receiving results of the graph database query; and generating, using the large language model, a natural language response to the natural language user query based on the results of the graph database query.

### FIELD

The present disclosure relates generally to cybersecurity, and more specifically to systems and methods for querying cybersecurity graph databases using natural language queries.

### BACKGROUND

Maintaining situational understanding of cybersecurity issues is critical for cybersecurity analysts. To stay informed as to how to effectively detect, analyze, and respond to cyber threats, analysts may need to consult cybersecurity data repositories. However, obtaining information from a cybersecurity data repository may require an analyst to use a graph query language specific to that data repository. Learning the structure and syntax of a graph query language can be complicated and time-consuming.

Furthermore, relevant information may be spread across a variety of data repositories, each of which may operate independently and have its own set of features, data structures, and interfaces. This disjointed structure can be a barrier to effective cybersecurity operations because an analyst may need to understand how to leverage multiple different graph query languages in order to locate the desired information. Using multiple graph query languages is inefficient and requires analysts to spend time and resources learning the languages and understanding the nuances of the underlying data models in order to formulate effective graph queries.

In addition, even if an analyst is able to formulate a graph query, the search results are often provided in an unfamiliar format (e.g., in a format that uses graph-specific terminology and/or syntax). Receiving the results in this manner can be time-consuming and difficult for analysts to understand.

### SUMMARY

Described herein are systems, methods, and non-transitory storage media for querying graph databases using natural language queries. The systems and methods described herein may allow a user to query a graph database using natural language. The systems and methods may utilize one or more large language models to convert the natural language user query into graph-specific query language that is submitted to a graph database. The results of the graph query received from the graph database can be converted to natural language using the same or a different large language model.

An exemplary method includes receiving a natural language user query and identifying one or more node types from a type graph in the natural language user query. The one or more node types may be identified using a large language model. A type graph may be a graph-based data model corresponding to a unified knowledge graph built from various data sources. The unified knowledge graph may contain information related to a specific domain (e.g., cybersecurity). The corresponding type graph may include a plurality of node types and edge types representing categories of information and their relationship in the unified knowledge graph. Based on the one or more node types identified in the natural language user query, a large language model may generate a graph database query (e.g., a Cypher query). The graph database query generated by the large language model may then be used to query a graph database (e.g., a Neo4j graph database). A large language model may then be used to generate a natural language explanation of the results of the graph database query that may be easily understood by the user.

A method for querying a graph database using natural language queries comprises: receiving a natural language user query; identifying one or more node types from a type graph in the natural language user query, wherein the one or more node types correspond to one or more words or phrases in the natural language user query; generating, using a large language model, a graph database query based on the one or more node types identified in the natural language user query; querying a graph database using the graph database query generated by the large language model; receiving results of the graph database query; and generating, using the large language model, a natural language response to the natural language user query based on the results of the graph database query.

In some embodiments, the type graph comprises a plurality of node types and a plurality of edge types. In some embodiments, the type graph comprises a semantic description of each node type and edge type. In some embodiments, the type graph comprises a name of a data source from which each node type and edge type originate. In some embodiments, the type graph is generated by: generating a knowledge graph, wherein the knowledge graph comprises a plurality of nodes and a plurality of edges; grouping the plurality of nodes into a plurality of node types and the plurality of edges into a plurality of edge types; generating a type graph comprising the plurality of node types, the plurality of edge types, a semantic description of each node type and edge type, and a name of a data source from which each node type and edge type originate. In some embodiments, the graph database comprises the knowledge graph and the type graph. In some embodiments, the method further comprises: identifying one or more unrecognized words or phrases in the natural language user query; querying a vector database with the one or more unrecognized words or phrases; and locating the one or more unrecognized words or phrases in the vector database. In some embodiments, the method further comprises adding one or more words or phrases in the natural language user query not located in the vector database to a list of words or phrases having unrecognized node types. In some embodiments, the vector database comprises a plurality of vectorized documents. In some embodiments, each vectorized document corresponds to a node of a knowledge graph. In some embodiments, locating the one or more unrecognized words or phrases in the vector database comprises: identifying, in the plurality of vectorized documents, one or more document portions semantically matching the one or more unrecognized words or phrases in the natural language user query; and adding node types and unique identifiers corresponding to the one or more document portions to a list of recognized node types. In some embodiments, the natural language response comprises an indication that the results of the graph database query fail to answer the natural language user query. In some embodiments, the method further comprises providing, to a user, an indication of one or more unrecognized words or phrases in the natural language user query that caused the results of the graph database query to fail to answer the natural language user query. In some embodiments, the method further comprises identifying one or more nodes, edges, or unexpected elements in the results; and adding the one or more nodes, edges, or unexpected elements to a results dictionary. In some embodiments, the method further comprises identifying graph-specific terminology in the natural language response; and re-wording the graph-specific terminology using natural language. In some embodiments, the method further comprises providing the natural language response to a user. In some embodiments, the method further comprises providing one or more visualizations corresponding to the results of the graph database query to a user. In some embodiments, the method further comprises generating, based on the knowledge graph, training data for offline fine-tuning of the large language model. In some embodiments, generating, based on the knowledge graph, training data for offline fine-tuning of the large language model comprises: selecting a first node and a second node from the knowledge graph, wherein the first node and the second node are connected by at least one path through the knowledge graph; identifying a shortest path between the first node and the second node; and generating one or more prompts, wherein a response to the one or more prompts comprises the shortest path between the first node and the second node. In some embodiments, generating, using a large language model, a graph database query comprises: generating a prompt for generating a graph database query, wherein the prompt comprises a user-role prompt component and a system-role prompt component; providing the prompt to the large language model; and receiving a graph database query from the large language model in response to the prompt. In some embodiments, the user-role prompt component comprises the natural language user query. In some embodiments, the system-role prompt component comprises a description of paths through the type graph between the one or more node types identified in the natural language user query. In some embodiments, the description of paths through the type graph is generated by: traversing one or more paths between each unique pair of node types identified in the natural language user query; and for each path, generating a graph database query match pattern corresponding to the path and a textual description corresponding to the path. In some embodiments, a first path through the type graph comprises a single step from a first node type identified in the natural language user query to a second node type identified in the natural language user query, wherein the first node type and second node type are connected by a first edge type. In some embodiments, a first path through the type graph comprises a plurality of steps from a first node type identified in the natural language user query to a second node type identified in the natural language user query via at least a third node type, wherein the first node type and third node type are connected by at least a first edge type, and the third node type and the second node type are connected by at least a second edge type. In some embodiments, the system-role prompt component comprises one or more n-example relevant traversals, wherein the one or more n-example relevant traversals are generated by: identifying a plurality of single-step traversals between node types in the type graph; for each single-step traversal, generating an example traversal comprising a description of the respective single-step traversal; embedding the example traversals in a vector database; querying the vector database with the natural language user query; and receiving the one or more n-example relevant traversals, wherein the one or more n-example relevant traversals comprise one or more example traversals corresponding to the natural language user query. In some embodiments, receiving results of the graph database query comprises: receiving a notification of an error in the graph database query; recasting, using the large language model, the graph database query to eliminate the error; querying the graph database using the recast graph database query generated by the large language model; and receiving results of the recast graph database query.

A computing system for querying a graph database using natural language queries includes one or more processors and memory storing one or more programs for execution by the one or more processors, the one or more programs comprising instructions that, when executed by the one or more processors, cause the system to perform a method comprising: receiving a natural language user query; identifying one or more node types from a type graph in the natural language user query, wherein the one or more node types correspond to one or more words or phrases in the natural language user query; generating, using a large language model, a graph database query based on the one or more node types identified in the natural language user query; querying a graph database using the graph database query generated by the large language model; receiving results of the graph database query; and generating, using the large language model, a natural language response to the natural language user query based on the results.

In some embodiments, the type graph comprises a plurality of node types and a plurality of edge types. In some embodiments, the type graph comprises a semantic description of each node type and edge type. In some embodiments, the type graph comprises a name of a data source from which each node type and edge type originate. In some embodiments, the type graph is generated by: generating a knowledge graph, wherein the knowledge graph comprises a plurality of nodes and a plurality of edges; grouping the plurality of nodes into a plurality of node types and the plurality of edges into a plurality of edge types; generating a type graph comprising the plurality of node types, the plurality of edge types, a semantic description of each node type and edge type, and a name of a data source from which each node type and edge type originate. In some embodiments, the graph database comprises the knowledge graph and the type graph. In some embodiments, the method further comprises: identifying one or more unrecognized words or phrases in the natural language user query; querying a vector database with the one or more unrecognized words or phrases; and locating the one or more unrecognized words or phrases in the vector database. In some embodiments, the method further comprises: adding one or more words or phrases in the natural language user query not located in the vector database to a list of words or phrases having unrecognized node types. In some embodiments, the vector database comprises a plurality of vectorized documents. In some embodiments, each vectorized document corresponds to a node of a knowledge graph. In some embodiments, locating the one or more unrecognized words or phrases in the vector database comprises: identifying, in the plurality of vectorized documents, one or more document portions semantically matching the one or more unrecognized words or phrases in the natural language user query; and adding node types and unique identifiers corresponding to the one or more document portions to a list of recognized node types. In some embodiments, the natural language response comprises an indication that the results of the graph database query fail to answer the natural language user query. In some embodiments, the method further comprises providing, to a user, an indication of one or more unrecognized words or phrases in the natural language user query that caused the results of the graph database query to fail to answer the natural language user query. In some embodiments, the method further comprises: identifying one or more nodes, edges, or unexpected elements in the results; and adding the one or more nodes, edges, or unexpected elements to a results dictionary. In some embodiments, the method further comprises: identifying graph-specific terminology in the natural language response; and re-wording the graph-specific terminology using natural language. In some embodiments, the method further comprises providing the natural language response to a user. In some embodiments, the method further comprises providing one or more visualizations corresponding to the results of the graph database query to a user. In some embodiments, the method further comprises generating, based on the type graph, training data for offline fine-tuning of the large language model. In some embodiments, generating, based on the knowledge graph, training data for offline fine-tuning of the large language model comprises: selecting a first node and a second node from the knowledge graph, wherein the first node and the second node are connected by at least one path through the knowledge graph; identifying a shortest path between the first node and the second node; and generating one or more prompts, wherein a response to the one or more prompts comprises the shortest path between the first node and the second node. In some embodiments, generating, using a large language model, a graph database query comprises: generating a prompt for generating a graph database query, wherein the prompt comprises a user-role prompt component and a system-role prompt component; providing the prompt to the large language model; and receiving a graph database query from the large language model in response to the prompt. In some embodiments, the user-role prompt component comprises the natural language user query. In some embodiments, the system-role prompt component comprises a description of paths through the type graph between the one or more node types identified in the natural language user query. In some embodiments, the description of paths through the type graph is generated by: traversing one or more paths between each unique pair of node types identified in the natural language user query; and for each path, generating a graph database query match pattern corresponding to the path and a textual description corresponding to the path. In some embodiments, a first path through the type graph comprises a single step from a first node type identified in the natural language user query to a second node type identified in the natural language user query, wherein the first node type and second node type are connected by a first edge type. In some embodiments, a first path through the type graph comprises a plurality of steps from a first node type identified in the natural language user query to a second node type identified in the natural language user query via at least a third node type, wherein the first node type and third node type are connected by at least a first edge type, and the third node type and the second node type are connected by at least a second edge type. In some embodiments, the system-role prompt component comprises one or more n-example relevant traversals, wherein the one or more n-example relevant traversals are generated by: identifying a plurality of single-step traversals between node types in the type graph; for each single-step traversal, generating an example traversal comprising a description of the respective single-step traversal; embedding the example traversals in a vector database; querying the vector database with the natural language user query; and receiving the one or more n-example relevant traversals, wherein the one or more n-example relevant traversals comprise one or more example traversals corresponding to the natural language user query. In some embodiments, receiving results of the graph database query comprises: receiving a notification of an error in the graph database query; recasting, using the large language model, the graph database query to eliminate the error; querying the graph database using the recast graph database query generated by the large language model; and receiving results of the recast graph database query.

A non-transitory computer-readable storage medium stores instructions that, when executed by one or more processors of an electronic device, cause the device to: receive a natural language user query; identify one or more node types from a type graph in the natural language user query, wherein the one or more node types correspond to one or more words or phrases in the natural language user query; generate, using a large language model, a graph database query based on the one or more node types identified in the natural language user query; query a graph database using the graph database query generated by the large language model; receive results of the graph database query; and generate, using the large language model, a natural language response to the natural language user query based on the results.

In some embodiments, any of the features of any of the embodiments described above and/or described elsewhere herein may be combined, in whole or in part, with one another.

Additional advantages will be readily apparent to those skilled in the art from the following detailed description. The aspects and descriptions herein are to be regarded as illustrative in nature and not restrictive.

### BRIEF DESCRIPTION OF THE FIGURES

A better understanding of the features and advantages of the present disclosure will be obtained by reference to the following detailed description that sets forth illustrative embodiments, in which the principles of the disclosure are utilized, and the accompanying drawings of which:

FIG. 1 illustrates an exemplary system for querying a graph database using natural language queries, according to some embodiments.

FIG. 2 illustrates an exemplary knowledge graph, according to some embodiments.

FIG. 3 illustrates an exemplary type graph, according to some embodiments.

FIG. 4 illustrates an exemplary method for querying a graph database using natural language queries, according to some embodiments.

FIG. 5 illustrates an exemplary system-role prompt for building a graph database query, according to some embodiments.

FIG. 6 illustrates an exemplary graph database query, according to some embodiments.

FIG. 7 illustrates an exemplary graph database query result, according to some embodiments.

FIG. 8 illustrates an exemplary natural language response to a natural language user query, according to some embodiments.

FIG. 9 illustrates an exemplary visualization of a graph database query result, according to some embodiments.

FIG. 10 illustrates an exemplary method for querying a graph database using natural language queries, according to some embodiments.

FIG. 11 illustrates an exemplary computing system, according to some embodiments.

### DETAILED DESCRIPTION

Described herein are systems and methods for querying graph databases using natural language queries and providing natural language explanations of the graph query results. Conventional methods of querying graph databases require knowledge of one or more graph query languages. As such, it can be challenging and time-consuming to formulate graph queries. Furthermore, even if a graph query is successfully formulated, the results of the graph query are typically expressed using graph-specific terminology and syntax, which can be challenging to read and understand. The disclosed systems and methods address these shortcomings.

Methods for querying a graph database using natural language queries can include receiving a natural language user query. For example, a user may input a natural language query to a user computing device, and the natural language query may be received from the user computing device by a query resolution system. The query resolution system can process the natural language user query to identify one or more node types of a type graph that are present in the natural language user query. For example, the query resolution system can use a large language model to parse the natural language user query to identify node types that correspond to one or more words or phrases in the natural language user query. Once the node types in the natural language user query are identified, an analytic orchestrator component of the query resolution system can build a prompt for a large language model, which may be the same or different than the large language model used to identify node types, to generate a graph database query based on the identified node types. The analytic orchestrator may then query a graph database using the graph database query generated by the large language model and receive the results of the graph database query. A large language model, which may be the same or different than the large language model(s) used to identify node types and/or generate the graph database query, may generate a natural language response to the natural language user query based on the results of the graph database query.

In some embodiments, the one or more node types identified in the natural language user query may correspond to a type graph corresponding to a unified knowledge graph. As used herein, a unified knowledge graph is a knowledge graph that aggregates information related to a specific domain (e.g., cybersecurity) from a plurality of data sources. The information in the unified knowledge graph may be provided as a plurality of nodes and a plurality of edges. The corresponding type graph may include a plurality of node types and edge types representing groupings of nodes and edges in the unified knowledge graph. One or more words or phrases in the natural language user query may correspond to one or more node types.

In some embodiments, the system may query a vector database to identify words or phrases in the natural language user query that do not directly match a node type. The vector database may include a plurality of documents embedded in vector space, wherein each document corresponds to a node of the knowledge graph. The vector database query may locate the closest semantic match to the words or phrases that do not directly match a node type.

In some embodiments, one or more large language models may be used to generate a graph database query based on the one or more node types identified in the natural language user query (and based on the results of the vector database query, if necessary). The one or more large language models may be provided with one or more prompts describing the node and edge types in the type graph, relevant paths through the type graph, a unique identifier for each node pertaining to a recognized entity in the natural language user query, and/or instructions (e.g., query syntax requirements) for the large language model for generating a graph database query. The one or more large language models may respond to the prompt with a graph database query, which includes syntax usable by the graph database.

In some embodiments, the graph database query generated by the large language model may then be used to query a graph database (e.g., a Neo4j graph database). If the graph database query yields results other than an error result, the results may be assembled into a common format (e.g., an ordered dictionary listing the nodes, edges, and other elements in the results) for further processing. The results of the graph database query may use graph-specific terminology and syntax. Because this format may be difficult for a user to understand, one or more large language models (the same or different than the one or more large language models used to generate the graph database query) may generate a natural language explanation of the results of the graph database query. The natural language explanation may be further refined by removing any remaining graph-specific terminology in the natural language explanation. Thus, the final response to the natural language user query is a natural language explanation that can be readily understood by a user.

In some embodiments, the large language model(s) used in the systems and methods provided herein may be fine-tuned using domain-specific training data. Training data may be generated based on the same knowledge graph used to answer user queries. Training the large language model(s) using the same knowledge graph used to answer user queries ensures that the large language model(s) are grounded in domain-specific knowledge, thereby improving the accuracy and relevance of responses to natural language user queries.

The techniques described herein may provide several technical advantages. The techniques described herein may facilitate user interaction with a computer by allowing users to provide queries and receive results using natural language. Enabling the exchange of information using natural language can help users process information more efficiently than they could if queries and results were provided in graphical terms. Furthermore, allowing users to query graph databases and receive results using natural language can make the information contained in graph databases more accessible, thereby enabling more informed decision-making by users. This may also enable users with varied skill sets to access information contained in graph databases, as users do not need to be proficient in graph query languages to use the systems and methods provided herein.

Additionally, the techniques described herein may enable system interoperability. The disclosed systems and methods enable system components that are conventionally incompatible (e.g., a large language model and a graph database) to operate together. The techniques provided herein may also enhance analytic capability as compared to conventional methods of querying graph databases and interpreting results. For example, a conventional approach to querying a cybersecurity database may require a cybersecurity analyst to engage another individual with expertise in creating graph database queries. If the graph database query expert is not also an expert in cybersecurity, the query that they generate (and the results that they explain) may be incomplete or inaccurate. Thus, by eliminating the potential for human error in translating between natural language and graph language, the approach provided herein may also provide more accurate results to a natural language user query.

Moreover, the systems and methods described herein may reduce the processing demands on a computer and thereby increase processing speed by utilizing a unified knowledge graph that combines a plurality of data sources, allowing users to search multiple data sources with a single query and eliminating the need to run multiple duplicative queries. Querying a unified knowledge graph may not only promote efficiency but also may provide a more comprehensive search result to the user. Furthermore, the techniques described herein may improve the functioning of a computer by fine-tuning a large language model using data generated from the same knowledge graph being queried, ensuring internal consistency and accuracy of the query results and grounding the large language models in domain-specific knowledge.

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed terms. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, storage medium, such as, but not limited to, any type of disk, including floppy disks, USB flash drives, external hard drives, optical disks, CD-ROMs, magneto-optical disks, read-only memories (ROMs), random access memories (RAMs), EPROMs, EEPROMs, magnetic or optical cards, application-specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear in the description below. In addition, the present invention is not described with reference to any particular programming language. It will be appreciated that a variety of programming languages may be used to implement the teachings of the present disclosure as described herein.

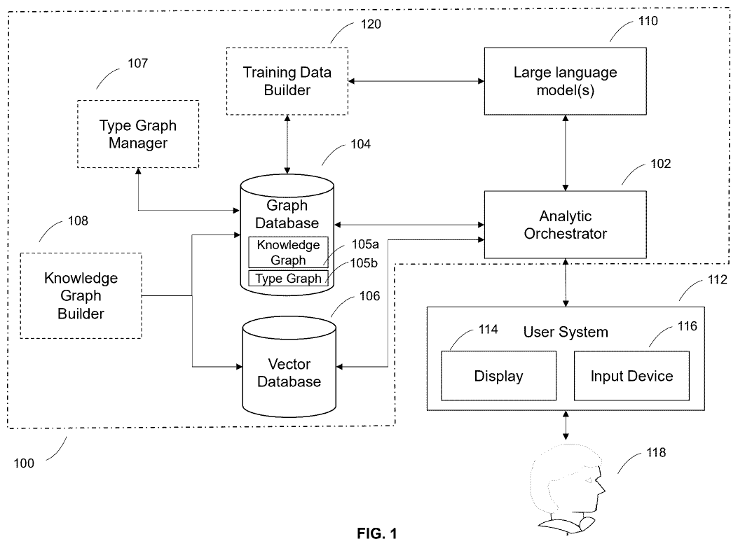

FIG. 1 illustrates an exemplary system 100 for querying a graph database using natural language queries, according to some embodiments. The components of system 100 may be provided on a single computing system or may be provided on multiple computing systems that are communicatively coupled to one another.

System 100 may include an analytic orchestrator 102. Analytic orchestrator 102 may be provided as software implemented on its own computing system and communicatively connected to the other components of system 100 or may be implemented on a computing system with one or more other components of system 100. Analytic orchestrator 102 may be a functional component that facilitates the graph database query process by coordinating the interaction between different components of system 100. For example, analytic orchestrator 102 may generate prompts for a large language model to build graph database queries, receive outputs from the large language model, and execute graph database queries built by the large language model.

Analytic orchestrator 102 may be configured to receive natural language user queries from a user system 112 that is connected to system 100. When analytic orchestrator 102 receives a natural language user query, analytic orchestrator 102 can prompt one or more large language model(s) 110 to generate a graph database query corresponding to the natural language user query. Analytic orchestrator 102 may then receive the graph database query from the large language model(s) and submit the graph database query to a graph database 104 to obtain query results. Analytic orchestrator 102 may also prompt large language model(s) 110 to generate a natural language explanation of the query results. Analytic orchestrator 102 can then receive the natural language explanation from large language model(s) 110 and provide them to user 118 via user system 112.

As mentioned, system 100 may include one or more large language model(s) 110 used to generate graph database queries and/or to generate natural language outputs from graph database query results. Large language model(s) 110 can receive prompts from analytic orchestrator 102 which contain instructions for identifying node types in a natural language user query, generating graph database queries, and/or generating natural language explanations of graph database query results. In some embodiments, the same large language model may be used to perform one or more of these tasks. In some embodiments, different large language models may be used to perform different tasks. The large language model(s) used may be specifically designed for these purposes or may be commercially available (e.g., Llama 2, Mistral, GPT Turbo 3.5, GPT 4). In examples that include multiple different large language models, the large language models may be implemented on the same computing system or on different computing systems, including on one or more cloud platforms.

System 100 may further include at least one graph database 104. Graph database 104 may be provided as software implemented on its own computing system and communicatively connected to the other components of system 100 or may be implemented on a computing system with one or more other components of system 100. Graph database 104 may be communicatively coupled to analytic orchestrator 102, such that analytic orchestrator 102 can query graph database 104 to resolve user queries based on the information in graph database 104. In some embodiments, graph database 104 may be a Neo4j, Amazon Neptune, ArangoDB, Azure Cosmos DB, JanusGraph, or TigerGraph graph database. In some embodiments, system 100 may include multiple different graph databases corresponding to different subject matter (e.g., a first graph database may contain information related to cybersecurity, while a second graph database may contain information related to physics).

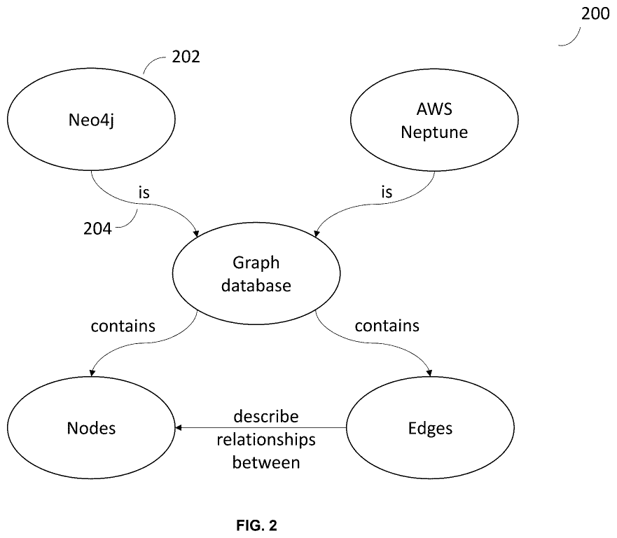

In some embodiments, graph database 104 may include at least one knowledge graph 105a comprising information about a topic (e.g., cybersecurity) and a corresponding type graph 105b. In some embodiments, graph database 104 may include a single knowledge graph and corresponding type graph. In some embodiments, graph database 104 may include multiple different knowledge graphs and type graphs. Different knowledge graphs and their corresponding type graphs may pertain to different subject matter (e.g., a first knowledge graph may contain information related to adversarial attacks, while a second knowledge graph may contain information related to mitigations). A knowledge graph 105a may be organized as a property graph containing nodes and edges. An example of a knowledge graph 105a is illustrated in FIG. 2. A knowledge graph 200 may include a plurality of nodes 202 and a plurality of edges 204. Each node 202 may correspond to an individual data entry in the knowledge graph 200, while each edge 204 may describe the relationship between two different nodes. For example, in FIG. 2, the node “Neo4j” may be related to the node “Graph Database” via the edge “is,” indicating that Neo4j is a type of graph database. Similarly, the node “Graph Database” may be related to the node “Nodes” via the edge “contains,” indicating that a graph database contains nodes. In some embodiments, properties may be defined for each node and edge (e.g., descriptions or labels). The knowledge graph may also include an optional overview detailing the nature of the knowledge graph. The overview may include codes indicating the data sources used to construct the knowledge graph and a timestamp indicating when the graph was created.

Returning to FIG. 1, knowledge graph 105a may be generated by a knowledge graph builder 108. Knowledge graph builder 108 may optionally be included in system 100. Knowledge graph builder 108 may be provided as software implemented on its own computing system or may be implemented on the same computing system as one or more other components of system 100. Knowledge graph builder 108 may be configured to receive information from one or more data sources and construct a knowledge graph and/or supplement an existing knowledge graph using the information. For example, knowledge graph builder 108 may create a knowledge graph related to cybersecurity by aggregating data sources containing data associated with adversarial attack techniques, computer vulnerabilities, defensive courses of action, and resiliency approaches. Knowledge graph builder 108 may be communicatively coupled to graph database 104, such that the resulting knowledge graph 105a can be provided to and stored in graph database 104.

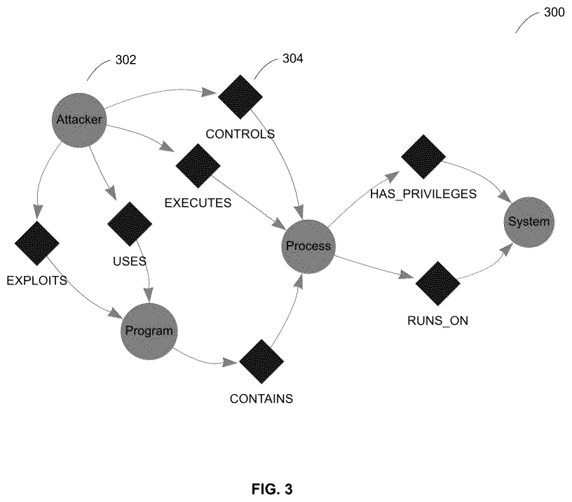

As noted above, graph database 104 may also include at least one type graph 105b that corresponds to knowledge graph 105a. Type graph 105b may describe the relationships between pieces of information in knowledge graph 105a by categorizing the nodes and edges of knowledge graph 105a into node types and edge types. An example of a type graph is illustrated in FIG. 3. In the illustrated example, type graph 300 describes the node types and edge types contained in a knowledge graph associated with information about cyber-attacks. Type graph 300 is organized in the same way as the knowledge graph which it describes, using a plurality of nodes to represent node types and a plurality of edges to represent edge types.

Type graph 300 includes a plurality of node types 302 (symbolized by circles) and a plurality of edge types 304 (symbolized by diamonds). Node types 302 may correspond to categories of nodes in the knowledge graph from which the type graph is derived. Nodes in the knowledge graph may correspond to individual data entries. Edge types 304 may correspond to categories of edges in the knowledge graph. Edges in the knowledge graph may describe relationships between nodes. Thus, if a knowledge graph contains information related to cyber-attacks, nodes may represent specific attacks or mitigations, and node types may represent groups of related attacks or mitigations. Edges may represent connections between the specific attacks or mitigations, and edge types may represent groups of related connections (e.g., controls, executes, uses, etc.).

As shown in FIG. 3, node types 302 may be connected to one another via edge types 304. As a result, various paths connecting node types can be traversed through the type graph 300. Paths can be described as phrases having the form <subject><predicate><object>. Paths describe how the node types in the type graph are related to one another via the edge types. For example, a path connecting node types may run from the node type “Attacker” to the node type “Program” via the edge type “exploits,” resulting in a path having the form “Attacker exploits Program.”

In some embodiments, a type graph 105b may further include semantic descriptions of each node type and edge type (e.g., the subject matter of the respective node type and edge type and the number of members of each element type). The descriptions may include verbose descriptions and/or terse descriptions for different analytic use cases. Verbose descriptions may provide comprehensive details of each node type and edge type in the type graph. Verbose descriptions are typically used when a large language model or a human user needs to understand the semantics of a node type or edge type in isolation. Terse descriptions are designed to explain to a large language model the semantics for composing multi-step traversal patterns through a type graph. A terse description may therefore include an explanation of the form <subject><predicate><object> for each traversal step in a type graph path, wherein the subject and object are node descriptions and the predicate is an edge description. Thus, each terse description explains the semantics of a single step in a type graph.

In some embodiments, type graph 105b of graph database 104 may be updated to reflect the most current information in knowledge graph 105a, such that user queries answered using the type graph are based on current information. In some embodiments, a type graph manager 107 can automatically update the type graph with new information (e.g., periodically or upon receipt of updated information by type graph manager 107). Type graph manager 107 may optionally be included in system 100. Type graph manager 107 may be provided as software implemented on its own computing system and communicatively connected to the other components of system 100 or may be implemented on a computing system with one or more other components of system 100. In some embodiments, type graph manager 107 may be communicatively coupled to graph database 104.

Type graph manager 107 can update a type graph 105b by building a type graph template, building a type graph description, and, optionally, generating a visualization of the new type graph. First, a type graph template may be constructed. A type graph template provides an overview of a knowledge graph from which a type graph can be constructed. A type graph template can include basic information about the knowledge graph including the name of the knowledge graph, a description of the domain knowledge contained in the knowledge graph, statistics about the knowledge graph, and information about the types of nodes and edges represented in the knowledge graph, how they are connected, and the numbers of members of each element type. Building a type graph template provides a systematic approach to extracting and organizing the elements of a knowledge graph and identifies any gaps or inconsistencies in the knowledge graph's node type information. In some embodiments, building the type graph template begins with iterating over the nodes in the knowledge graph to determine whether each node is new or is already present in the type graph template. If a node is new, the node may be added to an existing node type or a new node type may be created in the type graph template, as appropriate. The process is then repeated for the edges in the knowledge graph. A lookup table comprising node types for each unique node in the knowledge graph may also be constructed. The lookup table may be used to build a set of node type/edge type combinations. The node types, edge types, and node type/edge type combinations may then be added to the type graph template. Once the type graph template has been constructed, the type graph template can be combined with a previously built type graph description (e.g., a verbose description or a terse description). Any missing elements (e.g., node types or edge types in the new type graph template that are not found in the previously built type graph description) may be identified. A subject matter expert may then edit the type graph description to provide descriptions for any newly identified node types and/or edge types.

In some embodiments, type graph manager 107 may optionally generate a visualization of the updated type graph. The visualization may be provided to an operator, such as the subject matter expert described above. The visualization may also be provided to a user interface, such as display 114 of user system 112, if a user wishes to view the type graph used to answer a natural language user query. The visualization may include nodes and edges, wherein each node in the visualization represents a node type of the type graph and each edge in the visualization indicates the existence of one or more edges from a source node type to a target node type in the type graph. Each node type may be accompanied by the number of nodes of that type in the knowledge graph. Certain aspects of the visualization may be customizable by the user. For example, the user may choose to display or hide edge types. Displaying edge types may provide a fuller context for the user, while hiding edge types can enhance readability of the type graph.

In some embodiments, knowledge graph 105a and type graph 105b of graph database 104 can be used to resolve a natural language user query provided to system 100. A natural language user query can be provided to analytic orchestrator 102, for example via user system 112. Analytic orchestrator 102 may prompt a large language model 110 to identify words or phrases in the natural language user query that match the names of node types in type graph 105b, which can be used to build a graph database query.

In some embodiments, one or more words or phrases in a natural language user query may not directly match a node type of type graph 105b. In that case, analytic orchestrator 102 may be configured to query a vector database 106 to identify words or phrases in a natural language user query that do not directly match a name of a node type in order to construct an effective graph database query. Vector database 106 may include at least some of the information embodied in knowledge graph 105a in a different format. Querying vector database 106 may enable analytic orchestrator 102 to identify words or phrases that may not be recognized as corresponding directly to a name of a node type but are nonetheless present somewhere in the knowledge graph (e.g., embedded in a property of a node). In some embodiments, vector database 106 may include a plurality of information sets embedded in vector space. For example, the information sets may include vectorized documents, wherein each vectorized document or a portion thereof corresponds to a node in knowledge graph 105a. Each vectorized document may have a unique identifier, which may serve as a match criterion for a graph database query in downstream processing. In some embodiments, documents are split into smaller portions before being embedded in vector space. In some embodiments, similar documents (e.g., documents related to the same concept or containing the same key words or phrases) may be located near one another within the vector database. Vector database 106 may be provided as software implemented on its own computing system and communicatively connected to the other components of system 100 or may be implemented on a computing system with one or more other components of system 100.

System 100 may include or may be communicatively coupled to a user system 112. In some embodiments, user system 112 may be included in system 100. User system 112 may be any suitable computing system (e.g., smartphone, tablet, personal computer, client terminal, etc.). In some embodiments, user system 112 may be a separate system that is communicatively connected to system 100 by a network (e.g., a local area network, a wide area network, the Internet). User system 112 may include a functionality (e.g., an application running on a smartphone) configured to enable a user 118 to submit queries to and receive responses from the analytic orchestrator 102. User system 112 may include a display 114 (e.g., a computer monitor or a screen) and an input device 116 (e.g., a keyboard, a mouse, or a touch sensor).

Using input device 116, user 118 may provide natural language user queries to analytic orchestrator 102. For example, user 118 may ask a question about information contained in graph database 104 (e.g., if graph database 104 pertains to cybersecurity, a user may ask “What courses of action are associated with Netgear home routers?”). Outputs from analytic orchestrator 102 (e.g., natural language explanations of graph query results) may be provided to user 118 via display 114 of user system 112.

System 100 may optionally include a training data builder 120. Training data builder 120 may be provided as software implemented on its own computing system or may be implemented on the same computing system as one or more other components of system 100. Training data builder 120 may be used to generate data for fine-tuning of large language model(s) 110. Fine-tuning training data may be generated based on the knowledge graph 105a generated by knowledge graph builder 108 and stored in graph database 104. Generating training data using the same knowledge graph used to respond to user queries ensures that large language model(s) 110 is grounded in domain-specific knowledge, thereby improving the accuracy and relevance of responses to natural language user queries.

In some embodiments, training data builder 120 may be communicatively coupled to graph database 104. Training data builder 120 may receive a graph database endpoint identifier (e.g., a username and password required to access the graph database) and reconstruct the knowledge graph contained in the graph database endpoint as a formal graph object. The reconstructed knowledge graph may be used as a basis for generating a list of prompt dictionaries.

Prompt dictionaries may include training prompt and completion pairs generated based on the nodes and edges of the knowledge graph. For each node, training data builder 120 may generate training prompts (and corresponding responses to the prompts) such as: “What is the type and name for the node with the uid ‘{node_uid}’?” (wherein a “uid” is a unique identifier), “What is the type and name for the node with object dictionary ‘{dictionary_representation_of_node_contents}’?”, “What is the dictionary_representation_of_node_contents for a node with uid ‘{node_uid}’?”, and “What is a cypher query to return the node with uid “{node_uid}′?” For each property (key/value pair) of a node, training data builder 120 may generate training prompts (and corresponding responses to the prompts) such as: “For the node with uid ‘{node_uid}’, what is the value of the ‘{key}’ property?” and “What is the value of the ‘{key}’ property for the node with object dictionary ‘{dictionary_representation_of_node_contents}’?” For each edge, training data builder 120 may generate training prompts (and corresponding responses to the prompts) such as: “What is the type of edge from the node with uid ‘{edge_from}’ to the node with uid ‘{edge_to}’?”, “Is there an edge from the node with uid ‘{edge_from}’ to the node with uid “{edge_to}′?”, “What is the type for the edge with object dictionary ‘{dictionary_representation_of_edge_contents}’?”, and “What is a cypher query to return the edge from the node with uid “{edge_from}′ to the node with uid ‘{edge_to}’ and both the nodes that edge connects?” For each property (key/value pair) of an edge, training data builder 120 may generate training prompts (and corresponding responses to the prompts) such as: “For the edge from ‘{edge_from}’ to ‘{edge_to}’, what is the value of ‘{key}’ property?” For each of the prompts described, the corresponding response may be expressed in Neo4j Cypher.

Training data builder 120 may generate additional prompts and responses by performing random traversals through the knowledge graph. For a specified number of traversals, training data builder 120 may select two random nodes and find the shortest path between the two nodes using a breadth-first search algorithm. Starting points in random traversals may be biased in favor of node types that have more forward reachability. This may be determined by normalizing the number of outbound edges in the transitive closure for each node, forming a probability distribution over the nodes. A starting point may then be chosen based on the probability distribution. The target distance for a random traversal may be chosen according to a Poisson distribution, parameterized by the maximum distance from the starting node type. In some embodiments, rather than choosing random traversals for which to generate prompts and responses, training data builder 120 may traverse the full knowledge graph, resulting in a prompt/response pair for each pair of starting and ending node types in the knowledge graph.

Once random traversals (or a full traversal) are chosen, prompts and responses related to the traversals are then added to the generated list of prompt dictionaries. The prompts may include, for example: “Write a cypher query that gives a path starting from a node of type {n1_type}, going {path_length}, to a node of type {n2_type}”, “What is a cypher query for a path starting from a node of type {n1_type}, of length {path_length} steps, to a node of type {n2_type}?”, and “Write a cypher query that gives a path starting from the node with uid {node_1}, going {path_length} steps, to the node with uid {node_2}”. The responses may be provided in Neo4j Cypher. The generated list of prompts and responses may then be formatted according to the requirements of the large language model 110 that is being trained. For example, some open-source models require that the list be formatted as a JSON Lines file with one dictionary per line. Certain closed-source models (e.g., GPT Turbo 3.5) may have unique specifications for how training data must be formatted.

The training data generated by training data builder 120 may be used to train one or more of the large language model(s) 110 for fine tuning. The system may implement fine-tuning and evaluation pipelines to ensure optimal system performance and validate system competency. The pipelines may use the Transformers, PEFT, and DeepSpeed libraries, enabling training and inference with lower Video Random Access Memory (VRAM). The lower VRAM requirement allows the system to train open-source models.

To train an open-source model (e.g., a model for which source code is publicly available), a bash script comprising the number of available GPUs, the graph database endpoint identifier, username, password, and name of an open-source model stored in the safetensors format used by the huggingface.co platform may be generated. Using the script, the system may perform an environmental configuration with package installs, automated training data generating, Distributed Low-Rank Adapter training using the DeepSpeed optimization suite, and checkpointing during training. The output may include a set of model weights corresponding to a Low-Rank Adapter trained over knowledge graph data for the open-source model. The model weights, which may include an adapter configuration JSON and a binary file containing weight values, can be merged with the respective open-source model.

In some embodiments, the system may be equipped with robust logging and evaluation systems to ensure optimal performance and ease of debugging. The logging and evaluation systems may be useful due to the varying performance of large language models based on hyperparameter settings and user input. The logging system is designed to provide comprehensive system call information after inference is performed. The logging system may be built on top of the LangChain and Arize-Phoenix tools. The evaluation process for open-source models may begin with a user entering a query into the user interface or sending a call to the function directly. Upon receiving the user query, an OpenInference Tracer object may record a span, which is a nested organization of system pipeline inputs and outputs. This span, along with metadata about how many tokens were used and system latency, may then be sent to an Arize-Phoenix server. The server may record the information and make it accessible to a user via the user interface.

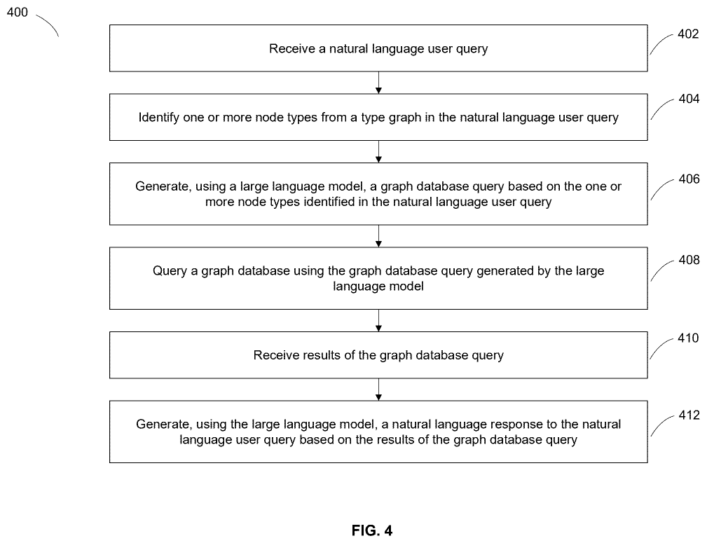

As described above, system 100 may be configured to receive a natural language user query and use one or more large language models to translate the natural language user query into graph-specific query language appropriate for querying a graph database. The system can query a graph database using the graph database query and use a large language model to translate the results into natural language to facilitate understanding by a user. FIG. 4 illustrates an exemplary method 400 that can be performed by system 100, according to some embodiments.

Method 400 is performed, for example, using one or more electronic devices implementing a software platform. In some embodiments, method 400 is performed using one or more electronic devices. In some embodiments, method 400 is performed using a client-server system, and the blocks of method 400 are divided up in any manner between the server and one or more client devices. Thus, while portions of method 400 are described herein as being performed by particular devices, it will be appreciated that method 400 is not so limited. In method 400, some blocks are optionally, combined, the order of some blocks is, optionally, changed, and some blocks are, optionally, omitted. In some embodiments, additional steps may be performed in combination with the method 400. Accordingly, the operations as illustrated (and described in greater detail below) are exemplary by nature and, as such, should not be viewed as limiting.

At step 402, a natural language query is received at a computing system. For example, the natural language user query may be received by analytic orchestrator 102 of system 100 described above with reference to FIG. 1. The natural language user query may be a command, question, or request for information expressed in natural language. For example, the natural language user query may be, “What courses of action are associated with Netgear home routers?” In some embodiments, the natural language user query may request domain-specific information (e.g., about cybersecurity). The natural language user query may be provided to the analytic orchestrator by a user via a user computing system, such as user system 112 described above with reference to FIG. 1. The user interface may include a user input functionality that enables a user to type a query and submit it to analytic orchestrator 102.

Step 404 includes identifying one or more node types of a type graph that are present in the natural language user query. Node types may be identified by a large language model 110 based on prompting from analytic orchestrator 102. As described above with reference to FIG. 3, a type graph may describe the structure and semantics of a knowledge graph. A natural language query may include one or more words or phrases corresponding to node types.

In some embodiments, a large language model may be used to identify one or more node types from the type graph in the natural language user query. The large language model may be a machine learning model trained for facilitating graph analysis. The large language model may be specifically designed for these purposes or may be a commercially available model (e.g., Llama 2, Mistral, GPT Turbo 3.5, GPT 4). To leverage the large language model, the analytic orchestrator may first build a prompt for the large language model. The prompt may include a user-role prompt and a system-role prompt, wherein the user role prompt includes the natural language user query, and the system-role prompt includes instructions for processing the natural language user query to extract node types. In some embodiments, the system-role prompt includes a description of node types in the type graph. The system-role prompt may also include instructions to identify parts of the natural language user query corresponding to node types and to identify any entities (e.g., words or phrases) that do not align with a recognized node type. The system-role prompt may include further instructions to ignore any entities that pertain to limiting analytic results to a certain number. The system-role prompt may also include instructions for formatting the results in a specified way for subsequent processing.

After formulating the prompt, the analytic orchestrator may submit the prompt to the large language model. The large language model may then identify one or more node types in the natural language user query in accordance with the prompt. In some embodiments, the output from the large language model may be provided as a JSON object conforming to the formatting specifications submitted in the system-role prompt. The JSON object may include a listing of node types identified in the natural language user request as well as a listing of entities that the large language model could not match to a recognized node type.

At step 406, a graph database query may be generated based on the one or more node types identified in the natural language user query. The graph database query may be generated by a large language model. The large language model used in step 406 may be the same large language model used to identify node types in the natural language user query in step 404 or may be a different large language model.

To leverage the large language model to build the graph database query, the analytic orchestrator may first build a prompt for the large language model. The prompt may include a user-role prompt (e.g., the natural language user query) and a system-role prompt. To build the system-role prompt, the analytic orchestrator may first generate a description of simple paths (e.g., paths that have no repeating nodes) through the type graph between the node types identified in the natural language user query in step 404. The description of simple paths is generated by first considering each possible pair of recognized node types from the natural language user query as a path source and a path target. Graph query alternatives may then be generated for each simple path that exists from source to target. For each simple path, the analytic orchestrator may generate a corresponding system-role prompt element that contains a graph query match pattern and a corresponding textual description. In addition to the simple paths through the type graph, the system-role prompt may further include unique identifiers for each individual node recognized in the natural language user query. The unique identifiers may be used to constrain the query.

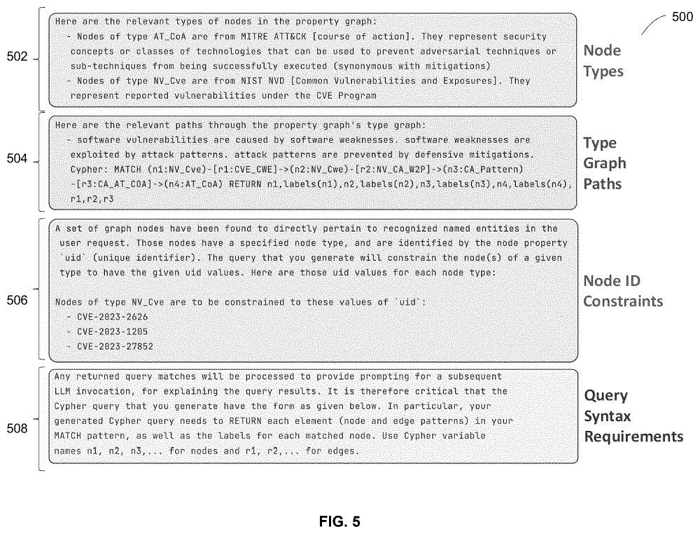

Therefore, the system-role prompt may include information about the node and edge types stored in the graph database, the relevant paths through the type graph stored in the graph database, the unique identifier for each node pertaining directly to recognized entities in the natural language user query, and instructions for the large language model for generating a graph database query in response to the natural language user query as required for processing of query results. The instructions may include query syntax requirements (e.g., guidelines for the variable names to be used for nodes and edges). An exemplary system-role prompt for building a graph database query is illustrated in FIG. 5. The system-role prompt 500 in FIG. 5 corresponds to a natural language user query “What courses of action are associated with Netgear home routers?” System-role prompt 500 includes four discrete sections: node types 502, type graph paths 504, node ID constraints 506, and query syntax requirements 508. Node types section 502 includes an enumeration of the node types identified in the natural language user query and an explanation of what each node type represents. For example, node types section 502 indicates that nodes of the type “AT_CoA” are present in the natural language user query and represent security concepts or classes of technologies that can be used to prevent adversarial techniques or sub-techniques from being successfully executed. Type graph paths section 504 lists the relevant paths through the type graph stored in the graph database. The enumerated paths through the type graph may explain the relationships between different node types identified in the natural language user query. For example, type graph paths section 504 explains that software vulnerabilities are caused by software weaknesses, software weaknesses are exploited by attack patterns, and attack patterns are prevented by defensive mitigations. Node ID constraints section 506 specifies the set of nodes that pertain directly to named entities in the natural language user query using their unique identifiers. The unique identifiers listed in node ID constraints section 506 (e.g., CVE-2023-2626) provide constraints for the graph database query. Finally, query syntax requirements section 508 provides instructions for the format of the graph database query to be generated by the large language model. As shown in FIG. 5, query syntax requirements section 508 emphasizes the need for the graph database query to return each element in the match pattern and the labels for each matched node and provides guidelines for using certain variable names for nodes and edges.

After formulating the prompt including the system-role prompt and the user-role prompt, the analytic orchestrator may provide the prompt to the large language model. Based on the prompt, the large language model may then generate one or more graph database queries. The one or more graph database queries generated by the large language model may be provided in a format suitable for querying the graph database (e.g., Cypher code). In some embodiments, the large language model may also provide a graph database query explanation along with the graph database query. The graph database query explanation may provide a detailed explanation of the graph database query in natural language.

In some embodiments, the system-role prompt may be augmented by generating additional automated prompts to enhance the process of retrieving data from the graph database. An exemplary automated prompt may include a simplified graph schema, wherein the simplified graph schema includes only names of node types and the properties that contain a specific substring. As an example, if ‘description’ is used as a substring in the prompt, the simplified graph schema may include node types with ‘short_description’, ‘long_description’, or ‘attack_flow_description’ as properties. Another exemplary automated prompt may involve the provision of n-example relevant traversals. N-example relevant traversals may be generated by identifying a plurality of single-step traversals between node types in the type graph. In some embodiments, each possible single-step traversal between all node types in the type graph may be identified. A description of each single-step traversal, referred to as an example traversal, may be generated by concatenating the description of an origin node, the description of the edge connecting the origin node to a destination node, and the description of the destination node. Using an embedding model, each example traversal may be embedded in a vector database, which may be a different vector database than vector database 106 described above with reference to FIG. 1. A vector database may be used because the vector database can store the embedded example traversals and be queried to find the closest embeddings to the embedding provided in a query. To generate automated prompts, the natural language user query may be queried against the vector database containing the example traversals. The query may return one or more relevant example traversals (n-example relevant traversals) corresponding to the natural language user query.

In some embodiments, the large language model may fail to generate a correct graph database query, at least on a first try. For example, the system may recognize syntax, database, or value errors in the generated graph database query. In the event of an error, the system may build error and response information into the next iteration of the prompt provided to the large language model.

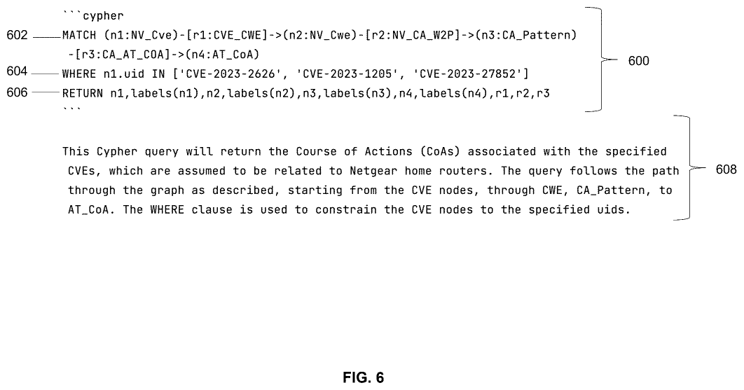

Step 408 includes querying a graph database using the graph database query generated by the large language model. The graph database query generated by the large language model may be received by analytic orchestrator 102 described above with reference to FIG. 1. The analytic orchestrator may then submit the query to a graph database, such as graph database 104. An exemplary graph database query is illustrated in FIG. 6. A graph database query 600 may include a “MATCH” clause 602, a “WHERE” clause 604, and a “RETURN” clause 606. In some embodiments, an explanation portion 608 may optionally be included along with graph database query 600 to facilitate review of the query by a user.

Graph database query 600 may be expressed in Cypher, or in any other suitable graph query language. As shown in FIG. 6, a Cypher query portion may include “MATCH” clause 602. “MATCH” clause 602 may describe a path through a type graph. For example, the “MATCH” pattern in FIG. 6 describes a path from vulnerability nodes (of node type NV_Cve) through software weakness nodes (of node type NV_Cwe) through attack pattern nodes (of node type CA_Pattern) to defensive mitigation nodes (of node type AT_CoA). “WHERE” clause 604 may provide constraints on which specific nodes should be included in the paths returned from the query. For example, the “WHERE” clause in FIG. 6 limits the CVE nodes to nodes having the unique identifiers (uid) CVE-2023-2626, CVE-2023-1205, and CVE-2023-27852. “RETURN” clause 606 may provide instructions for how the results of the query should be returned. For example, the “RETURN” clause in FIG. 6 instructs that the results should include each node in the match pattern, the labels for each matched node, and the relationships between the matched nodes.

Explanation portion 608 of graph database query 600 may include a natural language explanation of graph database query 600. For example, as shown in FIG. 6, explanation portion 608 may detail the structure of the results that graph database query 600 will return as well as how graph database query 600 is structured (e.g., what the function of the “WHERE” clause is).

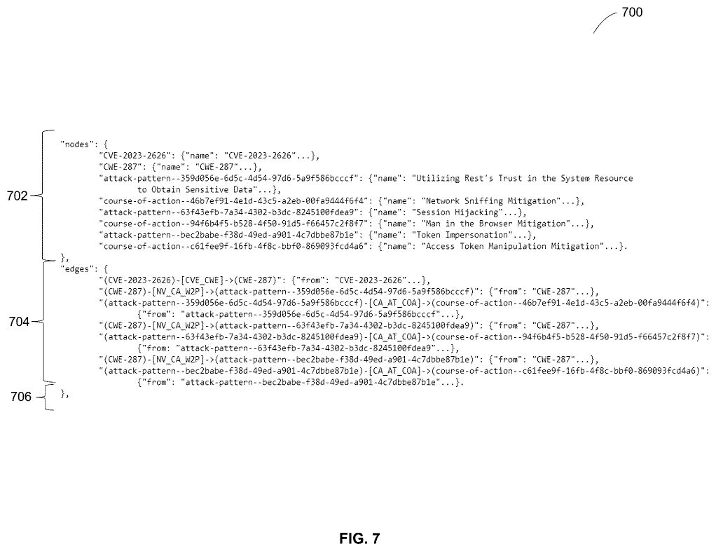

Step 410 includes receiving results of the graph database query. The results may be received from the graph database by the analytic orchestrator. The results of the graph database query may be provided as a list of dictionaries, wherein each dictionary is a match instance for the query match pattern specified in the graph database query. The results may contain the necessary data for responding to the natural language user query. The results may be expressed using graph-specific terminology, which can be translated into natural language to facilitate understanding by a user in one or more downstream processing steps. An exemplary graph database query result is illustrated in FIG. 7. A graph database query result 700 may include a plurality of elements returned based on a graph database query, such as graph database query 600 described above with reference to FIG. 6. The graph database query result shown in FIG. 7 corresponds to the graph database query shown in FIG. 6, which corresponds to the natural language user query “What CoAs (courses of action) are associated with Netgear home routers?” The results may include a list of elements organized by element type. The results may include a list of nodes 702, edges 704, and unexpected elements 706.

Graph database query result 700 may include a list of nodes 702, which may include all nodes retrieved based on the graph database query. Each node may be represented as a dictionary entry with the unique identifier of the node as the key and the properties of the node (e.g., name, type, description) as the value. For example, the node “CVE-2023-2626” is of the type “NV_Cve” and has a detailed description of the vulnerability it represents.

Graph database query result 700 may also include a list of edges 704, which may include all edges retrieved based on the graph database query. Each edge may be represented as a dictionary entry with the unique identifier of the edge as the key and the properties of the edge (the identities of the nodes that the edge connects, type of edge) as the value. For example, the edge “(CVE-2023-2626)-[CVE_CWE]→(CWE-287)” connects the nodes “CVE-2023-2626” and “CWE-287” and is of the type “CVE_CWE.”

Graph database query result 700 may further include a list of unexpected elements 706, which may include any elements from the query that do not conform to an expected category (e.g., node or edge). The list of unexpected elements 706 shown in FIG. 7 is empty, indicating that all elements in the graph database query results were successfully categorized as either nodes or edges in this example.

Step 412 includes generating, using the large language model, a natural language response to the natural language user query based on the results of the graph database query. The large language model may be the same large language model used to generate the graph database query in step 406 or may be a different large language model.

Before the large language model generates a natural language response to the natural language user query, the system may first build a prompt for the large language model. The prompt may include a user-role prompt and a system-role prompt. The user-role prompt may include the natural language user query, and the system-role prompt may include instructions to provide a detailed description of the scenario represented by the results of the graph database query in the context of the application domain.

The prompt may then be provided to the large language model. The output of the large language model may be a natural language response to the natural language user query that is based on the results of the graph database query. The natural language response may include a text narrative providing an interpretation of the results of the graph database query in a way that is meaningful and contextually relevant to the application domain. In some embodiments, the analytic orchestrator may receive the natural language response from the large language model and provide the natural language response to a user via a user interface, such as display 114 of user system 112 described above with reference to FIG. 1. The natural language response may facilitate understanding and interpretation of the results of the graph database query, especially for users who may be unfamiliar with reading and interpreting graph-specific language.

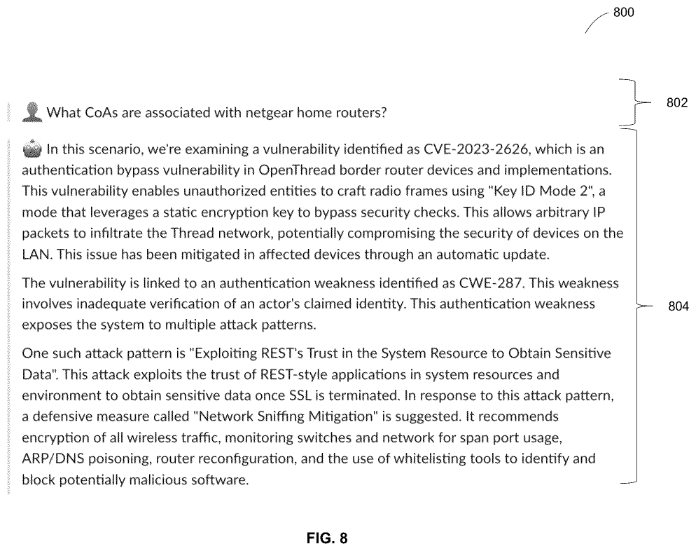

An exemplary natural language response is illustrated in FIG. 8. The natural language explanation 804 shown in FIG. 8 corresponds to the natural language user query 802 “What CoAs (courses of action) are associated with Netgear home routers?” The associated graph database query and graph database query result are shown in FIGS. 6 and 7, respectively. The natural language explanation 804 may be provided in response to a natural language user query 802. The query/explanation exchange 800 may be displayed via a user interface having a chat functionality, as shown in FIG. 8. The natural language explanation 804 may be generated by a large language model, which may receive results of a graph database query and translate the results from graph language into natural language.

As shown in FIG. 8, a natural language user query 802 asks about the courses of action (CoAs) related to Netgear home routers. The natural language explanation 804 includes a discussion of specific vulnerabilities, weaknesses, attack patterns, and defensive measures associated with Netgear home routers. For example, the natural language explanation 804 identifies a specific vulnerability called CVE-2023-2626, which is an authentication bypass vulnerability in OpenThread border router devices that allows unauthorized entities to bypass security checks, potentially compromising the security of devices on the LAN. The vulnerability is linked to an authentication weakness called CWE-287, which exposes the system to multiple attack patterns, such as “Exploiting REST's Trust in the System Resource to Obtain Sensitive Data.” The natural language explanation 804 then provides suggested defensive measures associated with the attack patterns (e.g., the “Network Sniffing Mitigation,” which involves encryption of all wireless traffic, monitoring switches and network for span port usage, ARP/DNS poisoning, router reconfiguration, and the use of whitelisting tools to identify and block potentially malicious software).

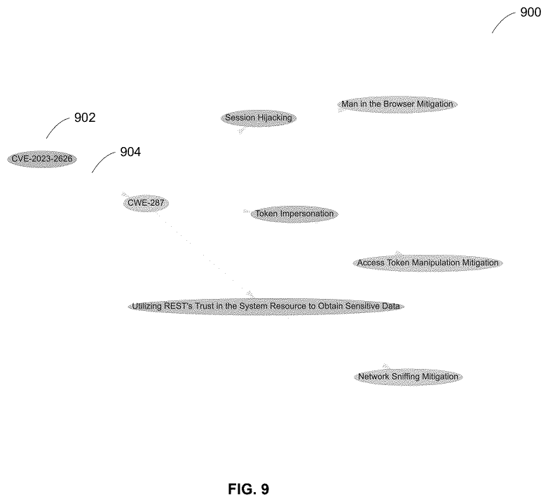

In some embodiments, the system may generate one or more visualizations corresponding to the natural language response that can be provided to a user. The visualization may include a graphical representation of the data. For instance, the visualization may include a graph comprising nodes and/or edges provided by the results of the graph database query. FIG. 9 illustrates an exemplary visualization of a graph database query result, according to some embodiments.

The visualization shown in FIG. 9 illustrates the results of graph database query result 700 shown in FIG. 7, which corresponds to graph database query 600 shown in FIG. 6. The original natural language user query associated with FIG. 9 is “What CoAs (courses of action) are associated with Netgear home routers?” The results of the graph database query may include one or more nodes 902 representing specific entities related to Netgear home routers. For example, nodes 902 may include specific vulnerabilities (e.g., CVE-2023-2626), software weaknesses (e.g., CWE-287), attack patterns (e.g., Utilizing REST's Trust in the System Resource to Obtain Sensitive Data, Token Impersonation, Session Hijacking), or suggested defensive measures (e.g., Network Sniffing Mitigation, Access Token Manipulation Mitigation, Man in the Browser Mitigation). The nodes 902 may be connected to one another via edges 904, which represent relationships between nodes. For example, the node “Session Hijacking” is connected to a node “Man in the Browser Mitigation.” The line between the two nodes is an edge that represents the relationship between the nodes. In the example shown in FIG. 9, the edges are not labeled, but the edge between “Session Hijacking” and “Man in the Browser Mitigation” is “mitigates.” Thus, FIG. 9 shows that the Man in the Browser Mitigation can be used to mitigate Session Hijacking with respect to Netgear home routers.

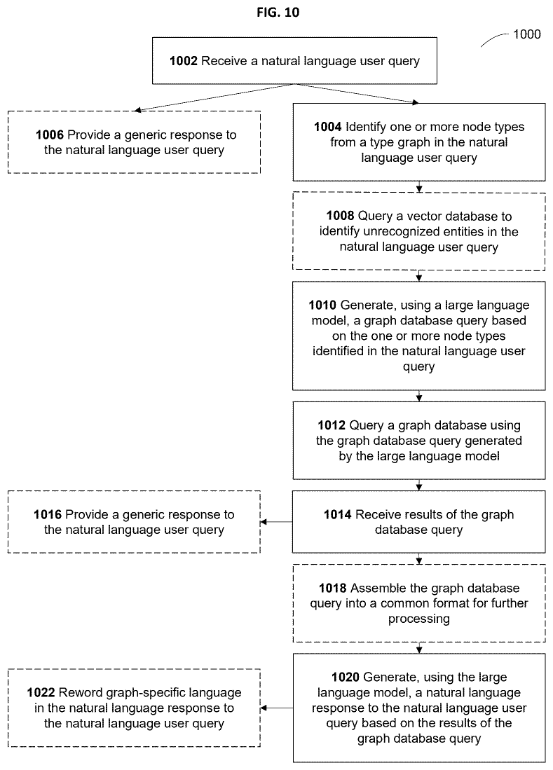

In some embodiments, a method for querying a graph database using natural language queries can include additional steps, for example if a query fails or if a natural language explanation of the graph database query results contains residual graph-specific terminology. FIG. 10 illustrates an exemplary method 1000 for querying a graph database using natural language queries, which is an extended variation of method 400 including optional processing steps. Method 1000 can be performed by system 100, as described above with reference to FIG. 1.

Method 1000 is performed, for example, using one or more electronic devices implementing a software platform. In some embodiments, method 1000 is performed using one or more electronic devices. In some embodiments, method 1000 is performed using a client-server system, and the blocks of method 1000 are divided up in any manner between the server and one or more client devices. Thus, while portions of method 1000 are described herein as being performed by particular devices, it will be appreciated that method 1000 is not so limited. In method 1000, some blocks are optionally, combined, the order of some blocks is, optionally, changed, and some blocks are, optionally, omitted. In some embodiments, additional steps may be performed in combination with the method 1000. Accordingly, the operations as illustrated (and described in greater detail below) are exemplary by nature and, as such, should not be viewed as limiting.

At step 1002, a natural language user query is received at a computing system (e.g., analytic orchestrator 102 of system 100). Step 1002 may share any one or more characteristics with step 402 described above with reference to FIG. 4.

At step 1004, a large language model may identify one or more node types of a type graph that are present in a natural language user query based on prompts from the analytic orchestrator. Step 1004 may share any one or more characteristics with step 404 described above with reference to FIG. 4.

In some embodiments, if the natural language user query does not contain any entities corresponding to node types in the type graph, method 1000 may proceed to step 1006 instead of step 1004. Step 1006 includes providing a generic response to the natural language user query. If no node types are identified in the natural language user query, the large language model may provide a generic response. For example, the large language model may acknowledge the natural language user query but explain the limitations of the system in providing the requested information and direct the user to a more appropriate source.

If one or more node types are successfully identified in the natural language user query, the method 1000 may optionally proceed from step 1004 to step 1008. At step 1008, the analytic orchestrator queries a vector database to identify unrecognized entities in the natural language user query. In some embodiments, a natural language user query may include unrecognized entities (e.g., words or phrases) that do not correspond to a recognized node type in the type graph and therefore may not be identified in step 1004. However, an unrecognized entity may still be present in the knowledge graph, even if it does not correspond to a node type. For example, the unrecognized entity may correspond to a specific node or property of a node. Any unrecognized entities may be identified by locating the semantically closest match to the unrecognized entities in a vector database before a graph database query is generated.

To resolve unrecognized entities, the analytic orchestrator must first determine whether the natural language user query contains any unrecognized entities. The analytic orchestrator may iterate over the list of unrecognized entities and query the graph database to determine whether the entry exists there. If an entry corresponding to the entity exists in the graph database, the entity may be added to a list of recognized node types. If an entry corresponding to the entity does not exist in the graph database, the analytic orchestrator may query a vector database (such as vector database 106 described above with reference to FIG. 1), wherein the vector database includes a plurality of vectorized documents. Each vectorized document or portion thereof may have a unique identifier and may correspond to a node in the knowledge graph.

Documents may be vectorized according to an embedding script. The embedding script may receive as input the graph database endpoint identifier, authentication information, and the name of the new vector database. Each node and edge in the graph may be embedded into vector space using the All-MiniLM-L6-v2 embedding model. Metadata may also be added to each node and edge specifying whether the feature is a node or edge. The vector representation of each element can be stored with the chroma library. The result of running the embedding script may be a named chromadb store of knowledge graph node or edge vector embeddings.

The result of a vector database query may include the closest document(s) (or portions thereof) to the query text located within the embedding vector space and the distance value(s) to each returned node document, wherein a distance value indicates how closely the returned document or document portion semantically matches the query text. If the entity is found in the vector database, the analytic orchestrator may add the entity to the list of recognized node types and remove the entity from the list of unrecognized entities. If the entity is not found in the vector database, the analytic orchestrator may add the entity to a list of words or phrases having unrecognized node types.

In some embodiments, the vector database can be queried via a web service. The web service may be implemented via the Flask framework. The web service may receive POST requests and respond with the appropriate vector database information. In some embodiments, a retrieval server may be an HTTP server that can receive a POST request in JSON format. The JSON request may include the query string (e.g., a term, phrase, or question) to be matched against the vector database. The request may also include a number of documents to be returned, in case the user wishes to limit the number of results for efficiency purposes. The request may further include the name of the vector database to be queried. The request may optionally specify a feature type (e.g., node or edge), such that a user can specify the type of data to be queried in order to generate more targeted results. Upon receiving the JSON request, the server may query the specified vector database with the query string and return the specified number of documents that are of the specified feature type. The result may be provided as a JSON-like structure including a list of L2 floats representing distances between the query string and the vector representing each document in the vector database. The distance may indicate similarity and/or relevance, wherein a smaller distance indicates a closer match to the query string. The result may further include a list of strings that contain the content in each node or edge originally contained in the knowledge graph and now part of the vector database. These are the documents that match the user query, providing the actual content requested in the user query. The result may also include a list of the types of graphical elements returned (e.g., nodes or edges) and/or other relevant metadata about the documents.

At step 1010, a large language model may generate a graph database query based on the one or more node types identified in the natural language user query. Step 1010 may share any one or more characteristics with step 406 described above with reference to FIG. 4.

At step 1012, the analytic orchestrator may query a graph database using the graph database query generated by the large language model. Step 1012 may share any one or more characteristics with step 408 described above with reference to FIG. 4.

At step 1014, the analytic orchestrator may receive results of the graph database query. Step 1014 may share any one or more characteristics with step 410 described above with reference to FIG. 4.

In some embodiments, if the graph database query yields an error result, the large language model may provide a generic response to the natural language user query at step 1016. The graph database query may yield an error result if the natural language user query does not contain enough recognized entities to form a meaningful query. In such a case, the large language model may provide a natural language explanation of which parts of the natural language user query are recognized as entities in the knowledge graph and which parts are not.

In some embodiments, if the graph database query yields non-error results, the analytic orchestrator may assemble the results of the graph database query into a common format for further processing at step 1018. The common format may include a retrieved results dictionary with retrieved nodes, edges, and other types of elements (e.g., summary statistics or unexpected properties). In some embodiments, the system may apply regular expressions to each element in a set of graph query results to determine whether each element is a node, edge, or other type of element. If the element does not match any expected pattern, the element may be labeled as an unexpected property. The system may then add each element to the appropriate category in the retrieved results dictionary (e.g., node, edge, or unexpected property). A new dictionary entry may be created for each node or edge identified in the results of the graph database query. For each retrieved node, the corresponding dictionary entry includes the node's name, type, and any other descriptive properties associated with the node. For each edge, the corresponding dictionary entry includes the edge's type and the nodes that the edge connects.

At step 1020, a large language model may generate a natural language response to the natural language user query based on the results of the graph database query. Step 1020 may share any one or more characteristics with step 412 described above with reference to FIG. 4.

At step 1022, the large language model can reword any remaining graph-specific language in the natural language response to the natural language user query. In some embodiments, the natural language response provided by the large language model may require further refinement to abstract any remaining graph-specific terminology from the natural language response. For example, formal terms from the type graph (e.g., the names of node types or edge types) may be removed in order to enhance reader comprehension of the natural language response. To abstract graph-specific terminology, the analytic orchestrator may generate a system-role prompt for the large language model that provides requirements for re-wording graph-specific language to common terminology in the application domain.

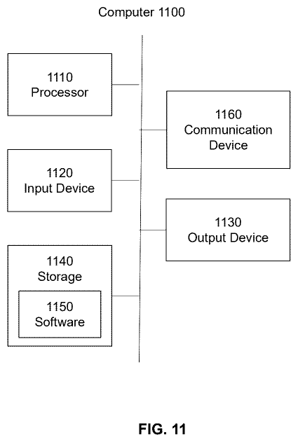

In one or more examples, the disclosed systems and methods utilize or may include a computer system. For example, the functional components of system 100 may run on a single computing system or on multiple computing systems that are communicatively connected to each other. FIG. 11 illustrates an exemplary computing system according to one or more examples of the disclosure. Computer 1100 can be a host computer connected to a network. Computer 1100 can be a client computer or a server. As shown in FIG. 11, computer 1100 can be any suitable type of microprocessor-based device, such as a personal computer, workstation, server, or handheld computing device, such as a phone or tablet. The computer can include, for example, one or more of processor 1110, input device 1120, output device 1130, storage 1140, and communication device 1160. Input device 1120 and output device 1130 can correspond to those described above and can either be connectable or integrated with the computer.

Input device 1120 can be any suitable device that provides input, such as a touch screen or monitor, keyboard, mouse, or voice-recognition device. Output device 1130 can be any suitable device that provides an output, such as a touch screen, monitor, printer, disk drive, or speaker.

Storage 1140 can be any suitable device that provides storage, such as an electrical, magnetic, or optical memory, including a random-access memory (RAM), cache, hard drive, CD-ROM drive, tape drive, or removable storage disk. Communication device 1160 can include any suitable device capable of transmitting and receiving signals over a network, such as a network interface chip or card. The components of the computer can be connected in any suitable manner, such as via a physical bus or wirelessly. Storage 1140 can be a non-transitory computer-readable storage medium comprising one or more programs, which, when executed by one or more processors, such as processor 1110, cause the one or more processors to execute methods described herein.

Software 1150, which can be stored in storage 1140 and executed by processor 1110, can include, for example, the programming that embodies the functionality of the present disclosure (e.g., as embodied in the systems, computers, servers, and/or devices as described above). For instance, software 1150 can include instructions for performing a method for querying a graph database using natural language queries, such as methods 400 or 1000 described above with reference to FIG. 4 or 10, respectively. In one or more examples, software 1150 can include a combination of servers such as application servers and database servers.

Software 1150 can also be stored and/or transported within any computer-readable storage medium for use by or in connection with an instruction execution system, apparatus, or device, such as those detailed above, that can fetch and execute instructions associated with the software from the instruction execution system, apparatus, or device. In the context of this disclosure, a computer-readable storage medium can be any medium, such as storage 1140, that can contain or store programming for use by or in connection with an instruction execution system, apparatus, or device.

Software 1150 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include but is not limited to, an electronic, magnetic, optical, electromagnetic, or infrared wired or wireless propagation medium.

Computer 1100 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 1100 can implement any operating system suitable for operating on the network. Software 1150 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

1. A method for querying a graph database using natural language queries, the method comprising:
receiving a natural language user query;
identifying one or more node types from a type graph in the natural language user query, wherein the one or more node types correspond to one or more words or phrases in the natural language user query;
generating, using a large language model, a graph database query based on the one or more node types identified in the natural language user query;
querying a graph database using the graph database query generated by the large language model;
receiving results of the graph database query; and
generating, using the large language model, a natural language response to the natural language user query based on the results of the graph database query.

2. The method of claim 1, wherein the type graph comprises a plurality of node types and a plurality of edge types.

3. The method of claim 2, wherein the type graph comprises a semantic description of each node type and edge type.

4. The method of claim 2, wherein the type graph comprises a name of a data source from which each node type and edge type originate.

5. The method of claim 1, wherein the type graph is generated by:
generating a knowledge graph, wherein the knowledge graph comprises a plurality of nodes and a plurality of edges;
grouping the plurality of nodes into a plurality of node types and the plurality of edges into a plurality of edge types;
generating a type graph comprising the plurality of node types, the plurality of edge types, a semantic description of each node type and edge type, and a name of a data source from which each node type and edge type originate.

6. The method of claim 5, wherein the graph database comprises the knowledge graph and the type graph.

7. The method of claim 1, comprising:
identifying one or more unrecognized words or phrases in the natural language user query;
querying a vector database with the one or more unrecognized words or phrases; and
locating the one or more unrecognized words or phrases in the vector database.

8. The method of claim 7, comprising:
adding one or more words or phrases in the natural language user query not located in the vector database to a list of words or phrases having unrecognized node types.

9. The method of claim 7, wherein the vector database comprises a plurality of vectorized documents.

10. The method of claim 9, wherein each vectorized document corresponds to a node of a knowledge graph.

11. The method of claim 9, wherein locating the one or more unrecognized words or phrases in the vector database comprises:
identifying, in the plurality of vectorized documents, one or more document portions semantically matching the one or more unrecognized words or phrases in the natural language user query; and
adding node types and unique identifiers corresponding to the one or more document portions to a list of recognized node types.

12. The method of claim 1, wherein the natural language response comprises an indication that the results of the graph database query fail to answer the natural language user query.

13. The method of claim 12, comprising:
providing, to a user, an indication of one or more unrecognized words or phrases in the natural language user query that caused the results of the graph database query to fail to answer the natural language user query.

14. The method of claim 1, comprising:
identifying one or more nodes, edges, or unexpected elements in the results; and
adding the one or more nodes, edges, or unexpected elements to a results dictionary.

15. The method of claim 1, comprising:
identifying graph-specific terminology in the natural language response; and
re-wording the graph-specific terminology using natural language.

16. The method of claim 1, comprising:
providing the natural language response to a user.

17. The method of claim 1, comprising:
providing one or more visualizations corresponding to the results of the graph database query to a user.

18. The method of claim 5, comprising:
generating, based on the knowledge graph, training data for offline fine-tuning of the large language model.

19. The method of claim 18, wherein generating, based on the knowledge graph, training data for offline fine-tuning of the large language model comprises:
selecting a first node and a second node from the knowledge graph, wherein the first node and the second node are connected by at least one path through the knowledge graph;
identifying a shortest path between the first node and the second node; and
generating one or more prompts, wherein a response to the one or more prompts comprises the shortest path between the first node and the second node.

20. The method of claim 1, wherein generating, using a large language model, a graph database query comprises:
generating a prompt for generating a graph database query, wherein the prompt comprises a user-role prompt component and a system-role prompt component;
providing the prompt to the large language model; and
receiving a graph database query from the large language model in response to the prompt.

21. The method of claim 20, wherein the user-role prompt component comprises the natural language user query.

22. The method of claim 20, wherein the system-role prompt component comprises a description of paths through the type graph between the one or more node types identified in the natural language user query.

23. The method of claim 22, wherein the description of paths through the type graph is generated by:
traversing one or more paths between each unique pair of node types identified in the natural language user query; and
for each path, generating a graph database query match pattern corresponding to the path and a textual description corresponding to the path.

24. The method of claim 22, wherein a first path through the type graph comprises a single step from a first node type identified in the natural language user query to a second node type identified in the natural language user query, wherein the first node type and second node type are connected by a first edge type.

25. The method of claim 22, wherein a first path through the type graph comprises a plurality of steps from a first node type identified in the natural language user query to a second node type identified in the natural language user query via at least a third node type, wherein the first node type and third node type are connected by at least a first edge type, and the third node type and the second node type are connected by at least a second edge type.

26. The method of claim 20, wherein the system-role prompt component comprises one or more n-example relevant traversals, wherein the one or more n-example relevant traversals are generated by:
identifying a plurality of single-step traversals between node types in the type graph;
for each single-step traversal, generating an example traversal comprising a description of the respective single-step traversal;
embedding the example traversals in a vector database;
querying the vector database with the natural language user query; and
receiving the one or more n-example relevant traversals, wherein the one or more n-example relevant traversals comprise one or more example traversals corresponding to the natural language user query.

27. The method of claim 1, wherein receiving results of the graph database query comprises:
receiving a notification of an error in the graph database query;
recasting, using the large language model, the graph database query to eliminate the error;
querying the graph database using the recast graph database query generated by the large language model; and
receiving results of the recast graph database query.

28. A computing system for querying a graph database using natural language queries, the computing system comprising one or more processors and memory storing one or more programs for execution by the one or more processors, the one or more programs comprising instructions that, when executed by the one or more processors, cause the system to perform a method comprising:
receiving a natural language user query;
identifying one or more node types from a type graph in the natural language user query, wherein the one or more node types correspond to one or more words or phrases in the natural language user query;
generating, using a large language model, a graph database query based on the one or more node types identified in the natural language user query;
querying a graph database using the graph database query generated by the large language model;
receiving results of the graph database query; and
generating, using the large language model, a natural language response to the natural language user query based on the results.

29. The system of claim 28, wherein the type graph comprises a plurality of node types and a plurality of edge types.

30. The system of claim 29, wherein the type graph comprises a semantic description of each node type and edge type.

31. The system of claim 29, wherein the type graph comprises a name of a data source from which each node type and edge type originate.

32. The system of claim 28, wherein the type graph is generated by:
generating a knowledge graph, wherein the knowledge graph comprises a plurality of nodes and a plurality of edges;
grouping the plurality of nodes into a plurality of node types and the plurality of edges into a plurality of edge types;
generating a type graph comprising the plurality of node types, the plurality of edge types, a semantic description of each node type and edge type, and a name of a data source from which each node type and edge type originate.

33. The system of claim 32, wherein the graph database comprises the knowledge graph and the type graph.

34. The system of claim 28, wherein the method further comprises:
identifying one or more unrecognized words or phrases in the natural language user query;
querying a vector database with the one or more unrecognized words or phrases; and
locating the one or more unrecognized words or phrases in the vector database.

35. The system of claim 34, wherein the method further comprises:
adding one or more words or phrases in the natural language user query not located in the vector database to a list of words or phrases having unrecognized node types.

36. The system of claim 34, wherein the vector database comprises a plurality of vectorized documents.

37. The system of claim 36, wherein each vectorized document corresponds to a node of a knowledge graph.

38. The system of claim 36, wherein locating the one or more unrecognized words or phrases in the vector database comprises:
identifying, in the plurality of vectorized documents, one or more document portions semantically matching the one or more unrecognized words or phrases in the natural language user query; and
adding node types and unique identifiers corresponding to the one or more document portions to a list of recognized node types.

39. The system of claim 28, wherein the natural language response comprises an indication that the results of the graph database query fail to answer the natural language user query.

40. The system of claim 39, wherein the method further comprises:
providing, to a user, an indication of one or more unrecognized words or phrases in the natural language user query that caused the results of the graph database query to fail to answer the natural language user query.

41. The system of claim 28, wherein the method further comprises:
identifying one or more nodes, edges, or unexpected elements in the results; and
adding the one or more nodes, edges, or unexpected elements to a results dictionary.

42. The system of claim 28, wherein the method further comprises:
identifying graph-specific terminology in the natural language response; and
re-wording the graph-specific terminology using natural language.

43. The system of claim 28, wherein the method further comprises:
providing the natural language response to a user.

44. The system of claim 28, wherein the method further comprises:
providing one or more visualizations corresponding to the results of the graph database query to a user.

45. The system of claim 32, wherein the method further comprises:
generating, based on the type graph, training data for offline fine-tuning of the large language model.

46. The system of claim 45, wherein generating, based on the knowledge graph, training data for offline fine-tuning of the large language model comprises:
selecting a first node and a second node from the knowledge graph, wherein the first node and the second node are connected by at least one path through the knowledge graph;
identifying a shortest path between the first node and the second node; and
generating one or more prompts, wherein a response to the one or more prompts comprises the shortest path between the first node and the second node.

47. The system of claim 28, wherein generating, using a large language model, a graph database query comprises:
generating a prompt for generating a graph database query, wherein the prompt comprises a user-role prompt component and a system-role prompt component;
providing the prompt to the large language model; and
receiving a graph database query from the large language model in response to the prompt.

48. The system of claim 47, wherein the user-role prompt component comprises the natural language user query.

49. The system of claim 47, wherein the system-role prompt component comprises a description of paths through the type graph between the one or more node types identified in the natural language user query.

50. The system of claim 49, wherein the description of paths through the type graph is generated by:
traversing one or more paths between each unique pair of node types identified in the natural language user query; and
for each path, generating a graph database query match pattern corresponding to the path and a textual description corresponding to the path.

51. The system of claim 49, wherein a first path through the type graph comprises a single step from a first node type identified in the natural language user query to a second node type identified in the natural language user query, wherein the first node type and second node type are connected by a first edge type.

52. The system of claim 49, wherein a first path through the type graph comprises a plurality of steps from a first node type identified in the natural language user query to a second node type identified in the natural language user query via at least a third node type, wherein the first node type and third node type are connected by at least a first edge type, and the third node type and the second node type are connected by at least a second edge type.

53. The system of claim 47, wherein the system-role prompt component comprises one or more n-example relevant traversals, wherein the one or more n-example relevant traversals are generated by:
identifying a plurality of single-step traversals between node types in the type graph;
for each single-step traversal, generating an example traversal comprising a description of the respective single-step traversal;
embedding the example traversals in a vector database;
querying the vector database with the natural language user query; and
receiving the one or more n-example relevant traversals, wherein the one or more n-example relevant traversals comprise one or more example traversals corresponding to the natural language user query.

54. The system of claim 28, wherein receiving results of the graph database query comprises:
receiving a notification of an error in the graph database query;
recasting, using the large language model, the graph database query to eliminate the error;
querying the graph database using the recast graph database query generated by the large language model; and
receiving results of the recast graph database query.

55. A non-transitory computer-readable storage medium storing instructions that, when executed by one or more processors of an electronic device, cause the device to:
receive a natural language user query;
identify one or more node types from a type graph in the natural language user query, wherein the one or more node types correspond to one or more words or phrases in the natural language user query;
generate, using a large language model, a graph database query based on the one or more node types identified in the natural language user query;
query a graph database using the graph database query generated by the large language model;
receive results of the graph database query; and
generate, using the large language model, a natural language response to the natural language user query based on the results.
